(19) United States
(12) Patent Application Publication
(10) Pub. No.: US 2026/0225561 A1
(43) Pub. Date: Aug. 6, 2026

(54) CONNECTION DEVICE FOR JOINING A BLADE TO A WIPER ARM

(71) Applicant: VALEO SYSTEMES D'ESSUYAGE, La Verriere (FR)

(72) Inventors: Thomas CAETANO, La Verriere (FR); Vincent GAUCHER, La Verriere (FR); Stephane HOUSSAT, La Verriere (FR)

(73) Assignee: VALEO SYSTEMES D'ESSUYAGE, La Verriere (FR)

(21) Appl. No.: 19/150,764

(22) PCT Filed: Jan. 19, 2024
(86) PCT No.: PCT/EP2024/051214

§ 371 Date: Jul. 24, 2025

(30) Foreign Application Priority Data
Jan. 27, 2023 (FR) FR2300806

(51) Int. Cl. B60S 1/40

(52) U.S. Cl. CPC B60S 1/4048; B60S 2001/4051; B60S 2001/4054

(57) ABSTRACT

The invention relates to a connection device for joining a wiper blade to a wiper arm, the device includes a first adapter and a second adapter configured to be mounted on the first adapter and to be positioned between the first adapter and the wiper arm, wherein the flexible tab of the second adapter carries a retaining fin that is arranged under a second locking button and extends under a locking projection of a first locking button, the retaining fin engaging with the locking projection of the first locking button of the first adapter to drive the movement of the first locking button with the second locking button when a pulling force is exerted on the second locking button.

TECHNICAL FIELD The present invention relates to a connecting device for assembling a windshield wiper blade to a windshield wiper arm. Another subject of the invention is a wiper device comprising a windshield wiper arm, a windshield wiper blade and a device for connecting the windshield wiper blade to the windshield wiper arm.

### BACKGROUND OF THE INVENTION

Motor vehicles are commonly fitted with wiper systems that are intended to clean their glazed surfaces, and in particular their windshield. Such wiper systems comprise a windshield wiper arm and a windshield wiper blade driven by said arm. The windshield wiper arm is connected to an electric motor of the vehicle and the windshield wiper blade comprises at least one wiper rubber designed to come into contact with the glazed surface to be wiped. In order to be able to drive the windshield wiper blade, a connecting system is arranged between the windshield wiper arm and a connector of the blade.

There are various kinds of arms, such as hook arms, arms with a lateral pivot pin, arms with longitudinal clip-fastening, rod arms, vertically locking arms, etc.

A connecting system is thus specifically configured to cooperate with vertically locking arms.

Given that there are also various types of vertically locking arms, the arms differing from one another in particular in terms of their dimensions and in terms of the positions of the opening intended to cooperate with the locking button, use is made, in some cases, of combinations of adapters.

A first connecting system comprising a first adapter and a module mounted on the first adapter is known, the first adapter comprising a flexible tab bearing a first locking button configured to lock the first connecting system to a first type of windshield wiper arm.

A second connecting system comprising a second adapter mounted on the first adapter is also known, the second adapter having a flexible tab bearing a second locking button configured to lock the assembly of the stack of adapters with a second type of windshield wiper arm. The second adapter has a very thin and flexible design so as to be able to be interposed between the first adapter and the arm.

Once the stack of adapters has been assembled in the yoke of the windshield wiper arm, it is desired for the adapters to remain assembled to the yoke while being subjected to a pulling force that can be applied by a user. This situation may occur, for example, in the case of a frozen windshield. The user tries to detach the blade from the windshield by pulling upward on the windshield wiper arm while the windshield wiper blade remains stuck to the windshield.

The vertical pulling force applied to the arm has the effect of pulling the second locking button upward, which risks unclipping the locking button or breaking the flexible tab bearing the second locking button

### SUMMARY OF THE INVENTION

One of the aims of the present invention is to propose a connecting device that makes it possible to prevent the windshield wiper blade from separating from the windshield wiper arm in the event of a pulling force being applied to the windshield wiper arm.

To this end, one subject of the invention is a connecting device for assembling a windshield wiper blade to a windshield wiper arm, having:
a first adapter comprising a flexible tab bearing a first locking button, the first locking button having a locking lug, and
a second adapter configured to be mounted on the first adapter and to be interposed between the first adapter and the windshield wiper arm, the second adapter having a flexible tab bearing a second locking button configured to lock the assembly of the second adapter with the windshield wiper arm,
characterized in that the flexible tab of the second adapter also bears a retaining fin arranged beneath the second locking button and extending beneath the locking lug of the first locking button, the retaining fin engaging with the locking lug of the first locking button of the first adapter so as to cause the first locking button to move with the second locking button when a pulling force is applied to the second locking button.

Once the second locking button has engaged with the first locking button, the strength of the second flexible tab bearing the second locking button is reinforced by that of the flexible tab bearing the first locking button. This takes advantage of the stack of adapters of the connecting device and of the fact that the first locking button of the first adapter has a locking lug for locking a first type of windshield wiper arm, in order to increase the rigidity of the second adapter.

The connecting device may also have one or more of the features that are described below, considered separately or in combination.

According to one exemplary embodiment, the retaining fin is plate-shaped.

According to one exemplary embodiment, once the retaining fin has engaged with the locking lug, the end of the retaining fin of the second adapter and the fold of the locking lug of the first adapter are spaced apart by a distance of between 0.1 mm and 3 mm.

According to one exemplary embodiment, once the retaining fin has engaged with the locking lug, the locking lug is configured to move forward over the retaining fin as the locking buttons rise. The greater the pulling force, the more the first locking button moves forward over the retaining fin and the more the vertical retention can be improved.

According to one exemplary embodiment, the locking lug is configured to move forward over the retaining fin until the end of the retaining fin comes into abutment in the fold of the locking lug. This prevents the two locking buttons from moving. This limits the rising of the second locking button in order to avoid it becoming unclipped from the yoke of the windshield wiper arm or the flexible tab supporting the second locking button breaking.

In the rest position, the second locking button can rest on the first locking button.

The first adapter can assemble a windshield wiper blade to a first type of windshield wiper arm, the locking lug of the first locking button being configured to lock the assembly of the first adapter with the yoke of the first type of windshield wiper arm.

Another subject of the invention is a wiper device comprising a windshield wiper arm and a windshield wiper blade, characterized in that it comprises a connecting device as described above, for connecting the windshield wiper blade to the end of the windshield wiper arm. One of the aims of the present invention is to propose a connecting device that makes it possible to prevent the windshield wiper blade from separating from the windshield wiper arm in the event of a pulling force being applied to the windshield wiper arm.

To this end, one subject of the invention is a connecting device for assembling a windshield wiper blade to a windshield wiper arm, having:
a first adapter comprising a flexible tab bearing a first locking button, the first locking button having a locking lug, and
a second adapter configured to be mounted on the first adapter and to be interposed between the first adapter and the windshield wiper arm, the second adapter having a flexible tab bearing a second locking button configured to lock the assembly of the second adapter with the windshield wiper arm,
characterized in that the flexible tab of the second adapter also bears a retaining fin arranged beneath the second locking button and extending beneath the locking lug of the first locking button, the retaining fin engaging with the locking lug of the first locking button of the first adapter so as to cause the first locking button to move with the second locking button when a pulling force is applied to the second locking button.

Once the second locking button has engaged with the first locking button, the strength of the second flexible tab bearing the second locking button is reinforced by that of the flexible tab bearing the first locking button. This takes advantage of the stack of adapters of the connecting device and of the fact that the first locking button of the first adapter has a locking lug for locking a first type of windshield wiper arm, in order to increase the rigidity of the second adapter.

The connecting device may also have one or more of the features that are described below, considered separately or in combination.

According to one exemplary embodiment, the retaining fin is plate-shaped.

According to one exemplary embodiment, once the retaining fin has engaged with the locking lug, the end of the retaining fin of the second adapter and the fold of the locking lug of the first adapter are spaced apart by a distance of between 0.1 mm and 3 mm.

According to one exemplary embodiment, once the retaining fin has engaged with the locking lug, the locking lug is configured to move forward over the retaining fin as the locking buttons rise. The greater the pulling force, the more the first locking button moves forward over the retaining fin and the more the vertical retention can be improved.

According to one exemplary embodiment, the locking lug is configured to move forward over the retaining fin until the end of the retaining fin comes into abutment in the fold of the locking lug. This prevents the two locking buttons from moving. This limits the rising of the second locking button in order to avoid it becoming unclipped from the yoke of the windshield wiper arm or the flexible tab supporting the second locking button breaking.

In the rest position, the second locking button can rest on the first locking button.

The first adapter can assemble a windshield wiper blade to a first type of windshield wiper arm, the locking lug of the first locking button being configured to lock the assembly of the first adapter with the yoke of the first type of windshield wiper arm.

Another subject of the invention is a wiper device comprising a windshield wiper arm and a windshield wiper blade, characterized in that it comprises a connecting device as described above, for connecting the windshield wiper blade to the end of the windshield wiper arm.

### BRIEF DESCRIPTION OF THE DRAWINGS

Other advantages and features will become apparent upon studying the following description of a particular, but in no way limiting, embodiment of the invention, and also the appended drawings, in which:

FIG. 1 is a perspective view of a wiper device.

FIG. 2 is an enlarged view of the wiper device in FIG. 1.

FIG. 3 is a perspective view of the connecting device of the wiper device in FIG. 1.

FIG. 4 is a side view of the connecting device in FIG. 3 when a pulling force is applied upward to the second locking button.

FIG. 5 is a view of the connecting device in FIG. 4 in the rest position.

FIG. 6 is a view of the connecting device in FIG. 3 in the disassembled state, the second adapter being located above and vertically in line with the first adapter.

FIG. 7 is a top view of the first adapter in FIG. 6.

FIG. 8A is a side view showing a first step of mounting the second adapter on the first adapter.

FIG. 8B is a view similar to FIG. 8A for a step following FIG. 8A.

FIG. 8C is a view similar to FIG. 8B for a step following FIG. 8B.

FIG. 8D is a view similar to FIG. 8C for a step following FIG. 8C.

FIG. 9A shows a first step of mounting the connecting device on the arm of the wiper device in FIG. 1.

FIG. 9B is a view similar to FIG. 9A for a step following FIG. 9A.

FIG. 9C is a view similar to FIG. 9B for a step following FIG. 9B.

FIG. 10A is a side view of the assembled connecting device when a pulling force is applied upward.

FIG. 10B is an enlarged view of the connecting device in FIG. 10A.

FIG. 10C is a view similar to FIG. 10A when the upward pulling force continues to be applied.

FIG. 10D is an enlarged view of the connecting device in FIG. 10C.

FIG. 11 is a perspective view of a windshield wiper arm connected to a first type of windshield wiper blade by means of the first adapter and of an additional module.

FIG. 12 is a perspective view of the additional module in FIG. 11 mounted on the first adapter.

FIG. 13 is a perspective view of the additional module in FIG. 12.

In these figures, identical elements bear the same reference numerals.

### DETAILED DESCRIPTION OF THE INVENTION

The following embodiments are examples. Although the description refers to one or more embodiments, this does not necessarily mean that each reference relates to the same embodiment, or that the features apply only to a single embodiment. Individual features of different embodiments can also be combined or interchanged to provide other embodiments.

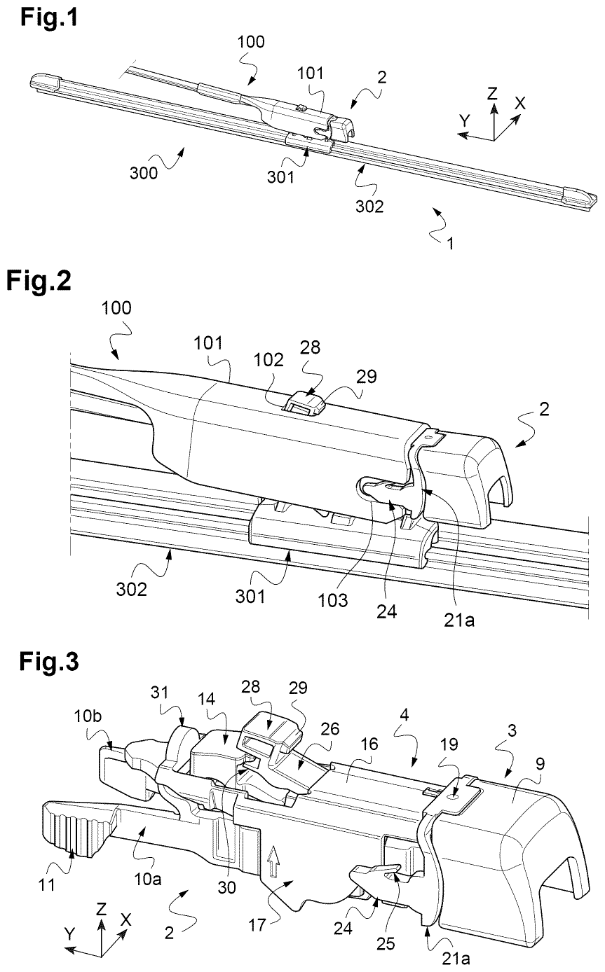

In the remainder of the description, the longitudinal direction Y, vertical direction Z and transverse direction X indicated in particular in FIG. 1 by the trihedral frame of reference (X, Y, Z) that is fixed with respect to the connecting device will be adopted non-limitingly. The longitudinal direction Y corresponds to the main direction in which the first adapter extends. The transverse direction X corresponds to the direction of the axis of rotation of the first adapter with the connector of the windshield wiper blade. The vertical direction Z and transverse direction X are perpendicular to the longitudinal direction Y and perpendicular to one another.

The “front” of the connecting device denotes the head side of the first and second adapter and the rear denotes the locking-tongue side of the first adapter.

The terms “upper” and “top” denote the side of the first adapter on which the second adapter is mounted and the terms “lower” and “bottom” denote the opposite side.

The terms “clip/unclip”, “clip-fasten/unfasten” and “snap-fasten/unfasten” are understood to mean a removable assembly produced by elastic deformation of one element in or on another element.

FIGS. 1 and 2 show a wiper device 1 comprising a windshield wiper arm 100 intended to be connected to a motorized wiper mechanism of a vehicle and the end of which has a yoke 101 connected to a windshield wiper blade 300 by means of a connecting device 2, in order to clean a glazed surface of the vehicle, for example a windshield.

The wiper device 1 is said to be “vertically locking”, since the connecting device 2 is inserted into the yoke 101 of the arm by movement in translation in the longitudinal direction Y and is locked in position by a locking button that can be actuated vertically with respect to the plane of the upper wall of the yoke 101.

As can best be seen in FIGS. 3 to 7, the connecting device 2 has a first adapter 3 and a second adapter 4, the second adapter 4 being configured to be mounted on the first adapter 3.

The connecting device 2 makes it possible both to lock the arm 100 to the connecting device 2 and to assemble a connector 301 of the windshield wiper blade 300 to the connecting device 2 in an articulated manner.

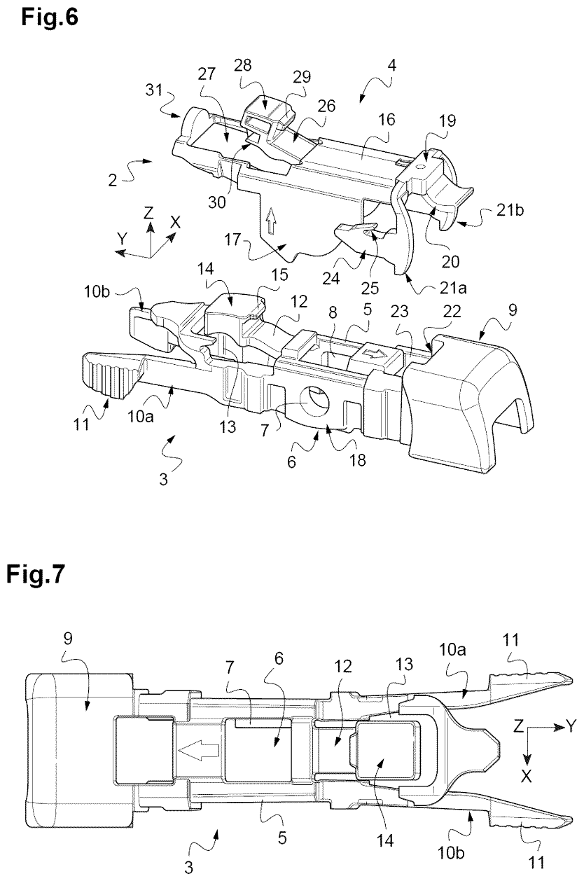

The first adapter 3 has a body 5 that extends mainly in a longitudinal direction Y and has a U-shaped cross section (in the plane (X, Z)) (FIG. 6).

In order to connect the first adapter 3 to the blade 300, the body 5 of the first adapter 3 has a connector housing 6 configured to cooperate with the connector 301 of the windshield wiper blade 300. The connector 301 is an element of the blade 300 surmounting a wiper rubber 302 of the blade 300 in its center (FIG. 1).

The rotation between the first adapter 3 and the connector 301 takes place about an axis of rotation parallel to the transverse direction X. According to an exemplary embodiment that can be seen in FIGS. 6 and 7, the first adapter 3 comprises, on one side, a cylindrical stud 7 configured to cooperate with a circular orifice of the connector 301, and, on the other side, a hole 8 configured to cooperate with a cylindrical stud of the connector 301, the cylindrical stud 7 and the hole 8 of the first adapter 3 being formed in walls that are parallel and on opposite sides of the connector housing 6.

The body 5 of the first adapter 3 is extended at one of its longitudinal ends by a head 9 and by two flexible locking tongues 10a, 10b at the other end, the connector housing 6 being interposed between the head 9 and the locking tongues 10, 10b.

The head 9 of the first adapter 3 has dimensions in the directions X, Y, Z that are larger than the body 5 of the first adapter and correspond to those of the yoke 101.

Each locking tongue 10a, 10b has a lateral locking portion 11 configured to cooperate with a lateral wall of the yoke 101 of the arm 100, the locking tongues 10a, 10b being able to be brought closer to one another by elastic deformation so as to allow the first adapter 3 to be mounted in the yoke 101.

The first adapter 3 also comprises a flexible tab 12 extending away from the head 9, into a rear opening 13 in the body 5 of the first adapter 3, above the upper wall of the body 5. The flexible tab 12 bears a first locking button 14 at its end. The first locking button 14 is also located above the rear opening 13 (FIG. 7).

The first locking button 14 has a locking lug 15 at a front end (FIG. 6). The lower face of the locking lug 15 may be planar. The length of the locking lug 15 may be shorter than the width of the first locking button 14.

The first adapter 3 may, in particular when it is used with one or more additional modules, assemble a windshield wiper blade 300 to first types of windshield wiper arm, the first locking button 14 being configured to lock the assembly of the first adapter 3 with the yoke 201 of the arm.

FIGS. 11 to 13 show an example of an assembly for a first type of windshield wiper arm 200.

In this example, the first type of windshield wiper arm 200 comprises a yoke 201 at its end having a U-shaped cross section in the plane (X, Z), an opening 202 being formed in the upper wall (FIG. 11).

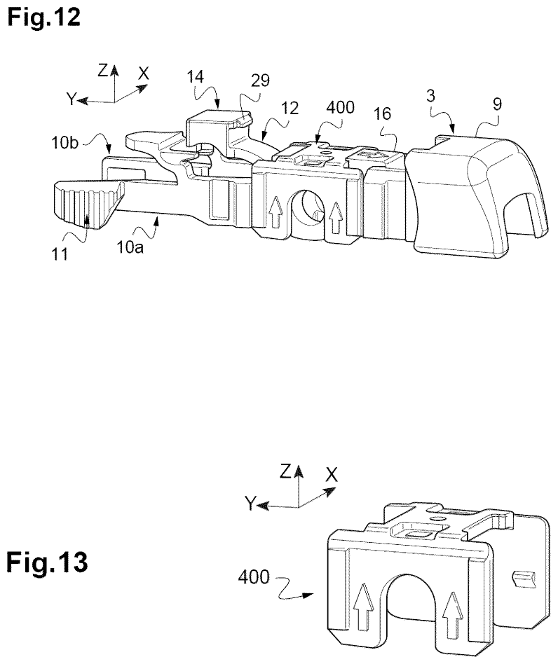

An additional module 400 in the form of a bracket (FIG. 13) is configured to be mounted on the first adapter 3 by engaging over thinned portions of the lateral walls of the body 5 of the first adapter 3 (FIG. 12) and thus to be interposed between the first adapter 3 and the yoke 201 of the arm 200.

During mounting in the yoke 201 of the first type of windshield wiper arm 200, the user presses the first locking button 14, which retracts in order to slide in the yoke 201. The first adapter 3 surmounted by the additional module 400 is then inserted into the yoke 201 of the windshield wiper arm 200 by movement in translation in the longitudinal direction Y. The locking tongues 10a, 10b are brought closer together by the yoke 201 and slide in the yoke 201.

When the yoke 201 comes into abutment against the head 9 of the first adapter 3, the lateral locking portions 11 of the locking tongues 10a, 10b bear against a respective lateral wall of the yoke 201 and the first locking button 14 is engaged by elastic snap-fastening in the corresponding opening 202 in the yoke 210, the locking lug 15 of the first adapter 3 forming a stop in the vertical direction, thereby locking the assembly of the first adapter 3 with the yoke 201 of the first type of windshield wiper arm 200 (FIG. 11).

In order to remove the first adapter 3, the user presses the first locking button 14, thereby making it possible to disengage the first adapter 3 from the yoke 201.

The first adapter 3 may also, when it is used with the second adapter 4, assemble a windshield wiper blade 300 to a second type of windshield wiper arm 100, the windshield wiper arm 100 as illustrated in FIGS. 1 and 2.

The second type of windshield wiper arm 100 comprises a yoke 101 at its end having a U-shaped cross section in the plane (X, Z), an opening 102 being formed in the upper wall and two lateral notches 103 being formed in a respective lateral wall of the yoke 101.

The second adapter 4 is configured to be mounted on the first adapter 3 and thus to be interposed between the first adapter 3 and the yoke 101 of the arm 100 in order to be able to assemble a windshield wiper blade 300 to the windshield wiper arm 100 of this second type.

As can best be seen in FIGS. 3 to 6, the second adapter 4 has a body 16 having a U-shaped cross section in the plane (X, Z) having two flanks 17. The flanks 17 engage over the lateral walls of the body 5 of the first adapter 3, in the thinned portions 18 of the lateral walls of the first adapter 3 (FIG. 6).

The body 16 of the second adapter 4 is extended by a head 19 at one of its longitudinal ends and by a tail 31 at the other end, the head 19 also being extended at the front by a strip 20 and on either side of the head 19 by two wings 21a, 21b.

The head 19 has a shape that is complementary to a notch 22 that is formed in the first adapter 3 and is, for example, parallelepipedal.

The head 19 of the second adapter 4 forms a stop for mounting the connecting device 2 in the yoke 101 of the windshield wiper arm 100 by movement in translation in the longitudinal direction Y.

The strip 20 extends downward so as to be able to be inserted into a front opening 23 in the first adapter 3 located behind the head 9, in order to be received in the head 9 of the first adapter 3. The strip 20 has a domed shape that is complementary to rounded reinforcements formed beneath the upper wall of the head 9 so as to be able to pivot about the reinforcements when the second adapter 4 is mounted on the first adapter 3, as will be seen below.

Each wing 21a, 21b is extended rearward by a lateral locking portion 24 bearing an elastic finger 25. The lateral locking portions 24 are configured to cooperate with a respective lateral notch 103 in the yoke 101 in order to clip the second adapter 4 to the yoke 101 of the arm 100 (FIG. 2).

The second adapter 4 also comprises a flexible tab 26, which extends the body 16 away from the head 19 and extends into an opening 27 in the body 16, above the upper wall of the body 16 (FIG. 5). The flexible tab 26 bears a second locking button 28 at its end.

The second locking button 28 is configured to lock the assembly of the second adapter 4 with the yoke 101 of the windshield wiper arm 100.

The second locking button 28 has a locking lug 29 at a front end. In the assembled position, the locking lug 29 forms a stop in the vertical direction for the windshield wiper arm 100 (FIG. 2).

The lower face of the locking lug 29 may be planar. The length of the locking lug 29 may be shorter than the width of the second locking button 28.

The flexible tab 26 of the second adapter 4 also bears a retaining fin 30.

The retaining fin 30 is arranged beneath the second locking button 28. It extends beneath the locking lug 15 of the first locking button 14 when the connecting device 2 is in the assembled state.

The retaining fin 30 is, for example, plate-shaped, in particular rectangular. The shape of the retaining fin 30 may be complementary to the lower face of the locking lug 15. The retaining fin 30 extends at the end of the flexible tab 26, its length extending in the transverse direction X parallel to the axis of rotation of the first adapter 3. The length of the retaining fin 30 in the transverse direction X is advantageously the same as the length of the second locking button 28 in order to optimize the contact length within a smaller space.

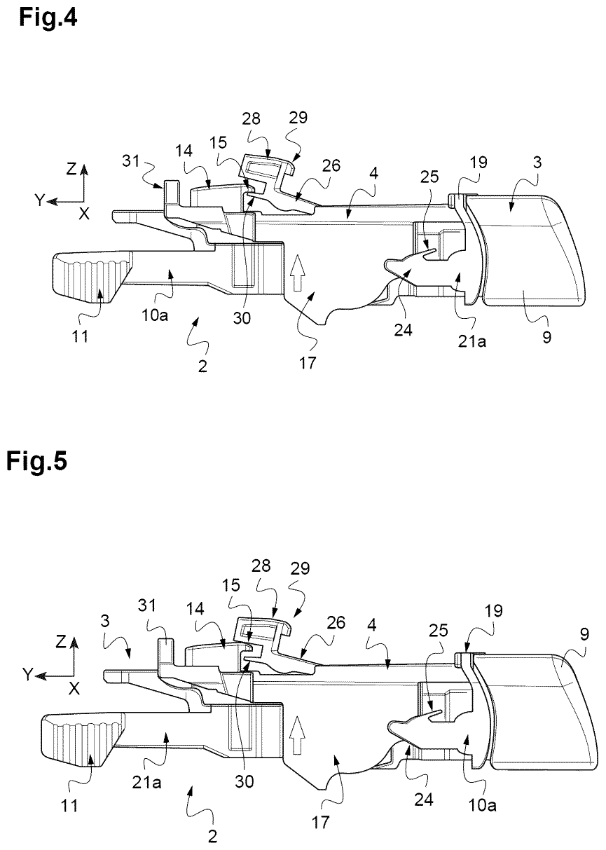

The retaining fin 30, the end of the flexible tab 26 and the lower wall of the second locking button 28 form a retaining groove having a U-shaped longitudinal section (FIG. 4).

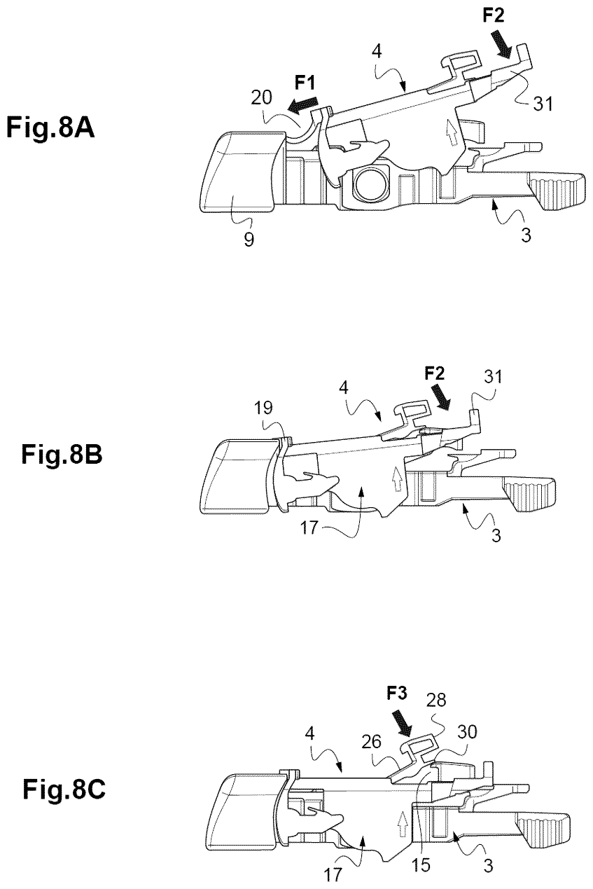

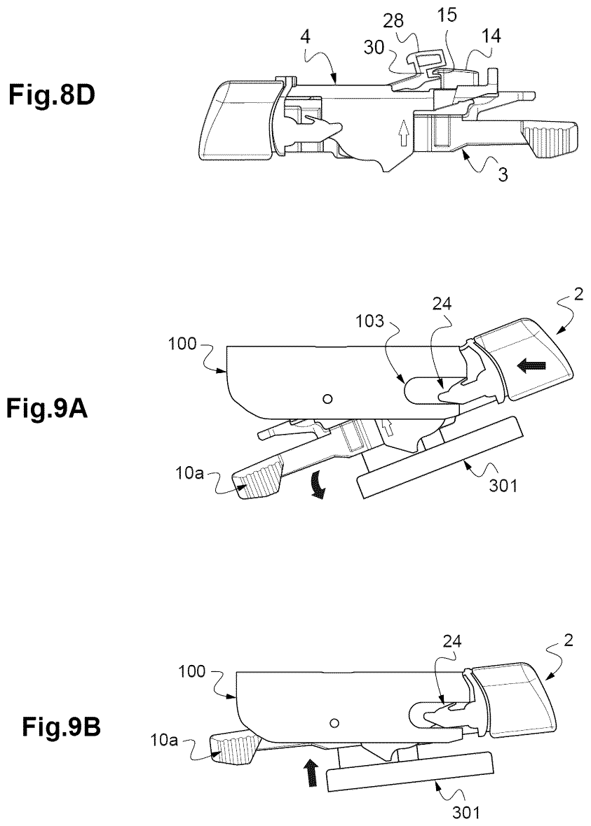

When the second adapter 4 is mounted on the first adapter 3, the starting point is to insert the strip 20 of the second adapter 4 into the front opening 23 in the first adapter 3 (FIG. 8A, arrow F1).

The strip 20 is then received in the head 9 of the first adapter 3 against reinforcements of complementary shape formed beneath the upper wall of the head 9 (FIG. 8B). Then, the tail 31 of the second adapter 4 is pushed against the first adapter 3 so as to pivot the first adapter 3 about the head 19 of the second adapter 3 (FIG. 8B, arrow F2). The flanks 17 of the second adapter 4 engage in the thinned portions 18 of the lateral walls of the first adapter 3. The locking button 14 of the first adapter 3 passes through the opening 27 in the second adapter 4.

The flexible tab 26 raises the second locking button 28, the retaining fin 30 being blocked by the locking lug 15 (FIG. 8C). The second locking button 28 is then pressed (FIG. 8C, arrow F3) until the retaining fin 30 engages beneath the locking lug 15 by snap-fastening (FIG. 8D).

Once assembled (FIG. 3), the connecting device 2 has an enlarged head, two wings 21a, 21b and a locking button that is raised with respect to the first adapter 3 alone. The locking tongues 10a, 10b are left free by the second adapter 4.

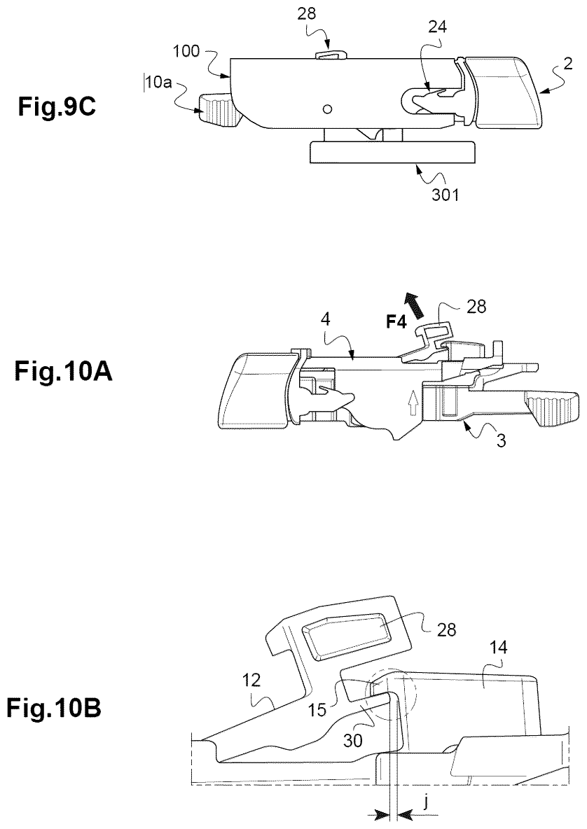

When the connecting device 2 is mounted in the yoke 101 of the arm 100 by movement in translation, the user has the lateral locking portions 24 of the lateral wings 21a, 21b in the lateral notches 103 in the yoke 101, the connecting device 2 being inclined such that the locking tongues 10, 10b are arranged beneath the arm 100 (FIG. 9A). Next, the user pivots the connecting device 2 in order to insert the locking tongues 10a, 10b into the yoke 101 (FIG. 9B), clip-fastening the second locking button 28 into the yoke 101 (FIG. 9C).

Once assembled (FIG. 2), the lateral locking portions 24 of the wings 21a, 21b are engaged in the lateral notches 103 in the yoke 101 of the arm 100, the lateral locking portions 11 of the locking tongues 10a, 10b are engaged against a respective lateral wall of the yoke 201, and the second locking button 28 is engaged by elastic snap-fastening in the corresponding opening 102 in the yoke 101 so as to lock the assembly of the connecting device 2 to the arm 100.

In order to remove the connecting device 2, the user presses the second locking button 28, thereby making it possible to disengage the connecting device 2 from the yoke 101.

In the rest position as illustrated in FIG. 5, i.e. when there is no pulling force being applied to the second locking button 28, the locking lug 15 of the first locking button 14 is located in the retaining groove, at a distance from the retaining fin 30. The second locking button 28, in particular a rear end, can rest on the first locking button 14.

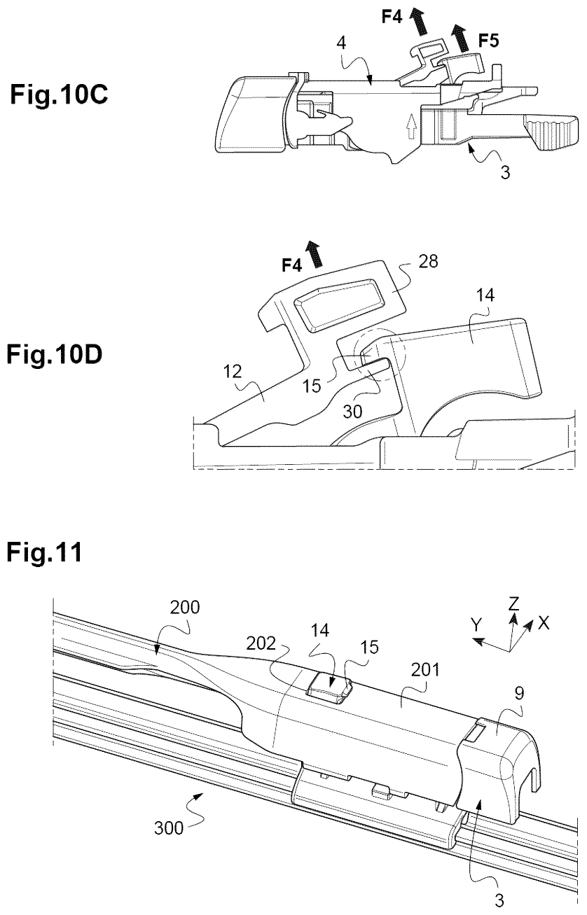

When a pulling force is applied upward to the second locking button 28 (FIG. 10A, arrow F4), for example due to a user pulling on the windshield wiper arm 100 while the windshield wiper blade 300 is stuck to the windshield, the second locking button 28 is raised and the retaining fin 30 engages with the locking lug 15 of the first locking button 14 of the first adapter 3 (FIGS. 4, 10A and 10B), which causes the first locking button 14 to move with the second locking button 28 (arrows F4, F5, FIGS. 10C, 10D). The term “engage” is understood to mean bringing the retaining fin 30 into bearing contact with the locking lug 15, engaging the movement of the two locking buttons 14, 28.

Once the second locking button 28 has engaged with the first locking button 14, the strength of the second flexible tab 26 bearing the second locking button 28 is reinforced by that of the flexible tab 12 bearing the first locking button 14. The second adapter 4 thus takes advantage of the additional rigidity provided by the flexible tab 12 of the first adapter 3. This takes advantage of the stack of adapters 3, 4 of the connecting device 2 and of the fact that the first locking button 14 of the first adapter 3 has a locking lug 15 for locking a first type of windshield wiper arm 200, in order to increase the rigidity of the second locking button 28.

When the retaining lug 15 of the first locking button 14 starts to come into contact with the retaining fin 30, the end of the retaining fin 30 is located at a distance from the fold of the locking lug 15 formed beneath the locking lug 15, between the locking lug 15 and the body of the first locking button 14 (FIG. 10B). The end of the retaining fin 30 of the second adapter 4 and the fold of the locking lug 15 of the first adapter 3 are for example spaced apart by a distance j of between 0.1 mm and 3 mm (FIG. 10B).

Next, the locking lug 15 can move forward over the retaining fin 30 as the locking buttons 14, 28 rise (FIG. 10C). The greater the pulling force, the more the first locking button 14 moves forward over the retaining fin 30 and the more the vertical retention can be improved.

If the pulling force continues to be applied, the locking lug 15 can move forward over the retaining fin 30 until the retaining fin 30 comes into abutment in the fold of the locking lug 15, canceling out the initial clearance j (FIG. 10D). This prevents the two locking buttons 14, 28 from moving. It is not possible to pull the second locking button 28 any further. This limits the rising of the second locking button 28 in order to avoid it becoming unclipped from the yoke 101 of the windshield wiper arm 100 or the flexible tab 26 supporting the second locking button 28 breaking.

The rigidity and vertical retention can thus be improved when faced with a pulling force despite the second adapter 4 having a very thin and flexible design and doing so within the small space available in the connecting device 2.

What is claimed is:

1. A connecting device for assembling a windshield wiper blade to a windshield wiper arm comprsing:
a first adapter including a flexible tab bearing a first locking button, the first locking button having a locking lug, and
a second adapter configured to be mounted on the first adapter and to be interposed between the first adapter and the windshield wiper arm the second adapter having a flexible tab bearing a second locking button configured to lock the assembly of the second adapter with the windshield wiper arm,
wherein the flexible tab of the second adapter also bears a retaining fin arranged beneath the second locking button and extending beneath the locking lug of the first locking button, the retaining fin engaging with the locking lug of the first locking button of the first adapter so as to cause the first locking button to move with the second locking button when a pulling force is applied to the second locking button.

2. The connecting device as claimed in claim 1, wherein the retaining fin is plate-shaped.

3. The connecting device as claimed in claim 1, wherein, once the retaining fin has engaged with the locking lug, the end of the retaining fin of the second adapter and a fold of the locking lug of the first adapter are spaced apart by a distance of between 0.1 mm and 3 mm.

4. The connecting device as claimed in claim 1, wherein, once the retaining fin has engaged with the locking lug, the locking lug is configured to move forward over the retaining fin as the locking buttons rise.

5. The connecting device as claimed in claim 4, wherein the locking lug is configured to move forward over the retaining fin until the end of the retaining fin comes into abutment in a fold of the locking lug.

6. The connecting device as claimed in claim 1, wherein, in the rest position, the second locking button rests on the first locking button.

7. A wiper device comprising a windshield wiper arm and a windshield wiper blade, comprising a connecting device for connecting the windshield wiper blade to the end of the windshield wiper arm, with the connecting device including a first adapter including a flexible tab bearing a first locking button, the first locking button having a locking lug, and a second adapter configured to be mounted on the first adapter and to be interposed between the first adapter and the windshield wiper arm, the second adapter having a flexible tab bearing a second locking button configured to lock the assembly of the second adapter with the windshield wiper arm, wherein the flexible tab of the second adapter also bears a retaining fin arranged beneath the second locking button and extending beneath the locking lug of the first locking button, the retaining fin engaging with the locking lug of the first locking button of the first adapter so as to cause the first locking button to move with the second locking button when a pulling force is applied to the second locking button.
